(19) United States
(12) Patent Application Publication
(10) Pub. No.: US 2021/0294417 A1
(43) Pub. Date: Sep. 23, 2021

(54) TOUCH DISPLAY DEVICE WITH VIBRATION FEEDBACK

(71) Applicant: Au Optronics Corporation, Hsinchu (TW)

(72) Inventor: Hui Chu Ke, Hsinchu (TW)

(73) Assignee: Au Optronics Corporation, Hsinchu (TW)

(21) Appl. No.: 17/013,665

(22) Filed: Sep. 7, 2020

(30) Foreign Application Priority Data
Mar. 18, 2020 (TW) 109108865

(51) Int. Cl. G06F 3/01; G06F 3/041; H02N 2/06

(52) U.S. Cl. CPC G06F 3/016; H02N 2/06; G06F 3/0412

(57) ABSTRACT

A touch display device with vibration feedback is provided. The touch display device includes a touch display panel, at least one actuator, and a control circuit. The touch display panel is configured to provide a touch signal. The actuator contacts the touch display panel. The control circuit is coupled to the touch display panel and the actuator, and controls the actuator to generate vibration feedback corresponding to a driving signal including a plurality of vibration waveforms during a tactile sensing period in response to the touch signal. At least one of the vibration waveforms is a single sine wave waveform or a half sine wave waveform, and the tactile sensing period is between 6 ms and 120 ms.

### CROSS-REFERENCE TO RELATED APPLICATION

This application claims the priority benefit of Taiwan application serial no. 109108865, filed on Mar. 18, 2020. The entirety of the above-mentioned patent application is hereby incorporated by reference herein and made a part of this specification.

### BACKGROUND

### Technical Field

The invention relates to a touch display device, and particularly relates to a touch display device with vibration feedback.

### Description of Related Art

Due to accumulation of semiconductor technology, development of touch interface has made the use of touch sensing input devices wider, and a large number of touch interfaces have been introduced for home and car use. In addition to user's input through the touch interface, it is hoped that the touch interface may feed back user's tactile sensing in the future. For example, an area of a touch panel inside a vehicle may be increased, and the touch panel may be used together with tactile feedback to replace traditional buttons, such that a driver does not need to look at the display panel to perform functional operations during driving. The display panel provides tactile feedback so that the driver knows what function has been selected, which improves driving safety. Moreover, general home appliances or touch panels equipped with the tactile feedback function may not only improve user experience, but may also help visually impaired people to operate more smoothly.

### SUMMARY

The invention is directed to a touch display device with vibration feedback, which is adapted to feed back a position or an icon touched by a user through different tactile sensations, and since the user may make confirmation without using eyes, it improves driving safety of the user or operation convenience of visually impaired people.

The invention provides a touch display device with vibration feedback, which includes a touch display panel, at least one actuator, and a control circuit. The touch display panel is configured to provide a touch signal. The actuator contacts the touch display panel. The control circuit is coupled to the touch display panel and the actuator, and controls the actuator to generate vibration feedback corresponding to a driving signal including a plurality of vibration waveforms during a tactile sensing period in response to the touch signal. At least one of the vibration waveforms is a single sine wave waveform or a half sine wave waveform, and the tactile sensing period is between 6 ms and 120 ms.

Based on the above description, the touch display device with vibration feedback of the embodiment of the invention controls a vibration mode of the actuator in response to the touch signal of the touch display panel, so as to generate a sharp pressing feeling, a continuous feeling . . . and other different tactile feelings through the vibration mode of the actuator. In this way, a position or an icon touched by a user may be fed back through different tactile sensations, and since the user may make confirmation without using eyes, it improves driving safety of the user or operation convenience of visually impaired people.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system schematic diagram of a touch display device according to an embodiment of the invention.

FIG. 2A to FIG. 2E are schematic diagrams of driving waveforms of a first type tactile feedback expression according to an embodiment of the invention.

FIG. 3A to FIG. 3E are schematic diagrams of driving waveforms of a second type tactile feedback expression according to an embodiment of the invention.

FIG. 4A to FIG. 4H are schematic diagrams of driving waveforms of a third type tactile feedback expression according to an embodiment of the invention.

FIG. 5A to FIG. 5J are schematic diagrams of driving waveforms of a fourth type tactile feedback expression according to an embodiment of the invention.

### DESCRIPTION OF THE EMBODIMENTS

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should be noted that although the terms “first”, “second”, “third”, etc. may be used for describing various elements, components, regions, layers and/or portions, the elements, components, regions, layers and/or portions are not limited by these terms. These terms are only used for separating one element, component, region, layer or portion from another element, component, region, layer or portion. Therefore, the following discussed “first element”, “component”, “region”, “layer” or “portion” may be referred to as a second element, component, region, layer or portion without departing from the scope of the invention.

The terminology used herein is for the purpose of describing particular embodiments and is not intended to be limiting of the invention. As used herein, the singular forms “a,” “an” and “the” are intended to include the plural forms as well, unless the context clearly indicates otherwise. “or” represents “and/or”. The term “and/or” used herein includes any or a combination of one or more of the associated listed items. It will be further understood that the terms “comprises,” “comprising,” “includes” and/or “including,” when used herein, specify the presence of stated features, regions, integers, steps, operations, elements, and/or components, but do not preclude the presence or addition of one or more other features, regions, integers, steps, operations, elements, components, and/or groups thereof.

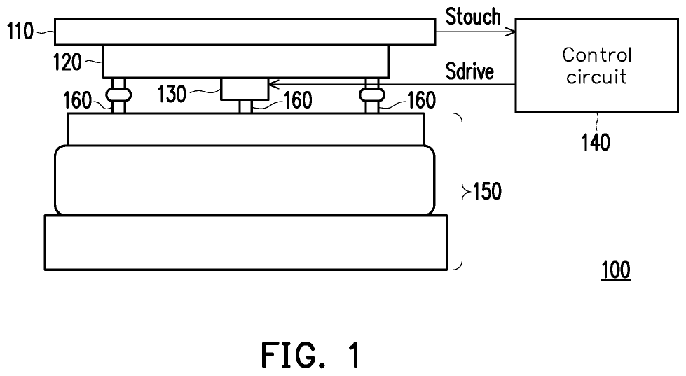

FIG. 1 is a system schematic diagram of a touch display device according to an embodiment of the invention. Referring to FIG. 1, in the embodiment, the touch display device 100 has vibration feedback, and includes a touch display panel 110, a backlight module 120, at least one actuator 130 (one actuator is shown here as an example), a control circuit 140, a back plate structure 150, and a plurality of support members 160. The backlight module 120 is disposed on the back plate structure 150 through the support members 160, and the touch display panel 110 is attached to the backlight module 120. The actuator 130 is fixed between the backlight module 120 and the back plate structure 150 through the support member 160, so as to contact the touch display panel 110 through the backlight module 120.

The touch display panel 110 is configured to provide a touch signal Stouch. The control circuit 140 is coupled to the touch display panel 110 and the at least one actuator 130 to receive the touch signal Stouch. The control circuit 140 determines a touch position/action according to the touch signal Stouch, and in response to the touch position/action indicated by the touch signal Stouch, the control circuit 140 controls the actuator 130 to generate vibration feedback corresponding to a driving signal Sdrive including a plurality of vibration waveforms during a tactile sensing period, so as to feed back whether the touch display panel 110 is touched and feed back a pressing status. The actuator 130 may be configured at a specific position or a position corresponding to a specific icon, which may be determined according to an actual circuit design.

At least one of the vibration waveforms of the driving signal Sdrive is a single sine wave waveform, a half sine wave waveform, or a single square wave waveform, and the tactile sensing period is between 6 ms and 120 ms.

In the embodiment of the invention, the actuator 130 may be a linear resonant actuator, where a vibration frequency of the linear resonant actuator is between 100 Hz and 300 Hz. Since too low or too high vibration frequency may weaken a vibration force, the vibration frequency of the actuator 130 applied to the touch display panel 110 is between 140 Hz and 190 Hz.

It is assumed that 2-12 vibration waveforms of the driving signal Sdrive represent a touch operation, the tactile sensing period corresponding to the vibration frequency of 100 Hz is 20 ms (2 vibration waveforms)-120 ms (12 vibration waveforms), and the tactile sensing period corresponding to the vibration frequency of 300 Hz is 6 ms (2 vibration waveforms)-40 ms (12 vibration waveforms), so that the tactile sensing period of the embodiment of the invention may be between 6 ms and 120 ms.

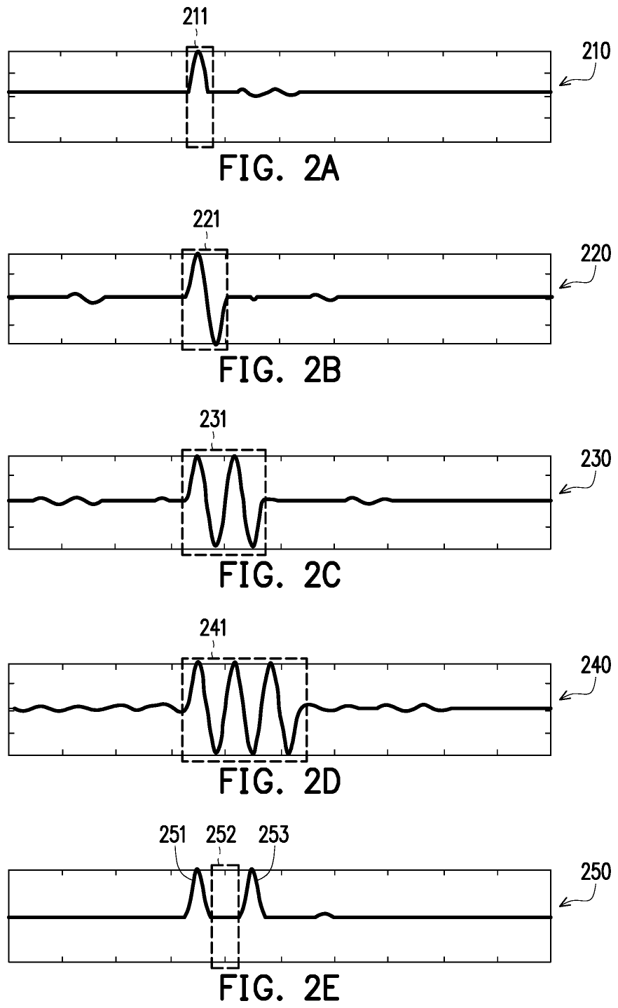

FIG. 2A to FIG. 2E are schematic diagrams of driving waveforms of a first type tactile feedback expression according to an embodiment of the invention. Referring to FIG. 2A to FIG. 2E, in the embodiment, the first type tactile feedback expression corresponds to a single-click touch (i.e., the touch signal Stouch corresponds to the single-click touch), at this time, driving signals 210, 220, 230, 240, and 250 have only one set of vibration combination. Further, the vibration combination of the single-click touch requires less than 0.03 seconds to avoid trailing tactile sensing and create a feeling of pressing once.

In FIG. 2A, the vibration combination of the driving signal 210 has a half sine wave waveform 211. In FIG. 2B, the vibration combination of the driving signal 220 has a single sine wave waveform 221. In FIG. 2C, the vibration combination of the driving signal 230 has two consecutive single sine wave waveforms 231. In FIG. 2D, the vibration combination of the driving signal 240 has three consecutive single sine wave waveforms 241. In FIG. 2E, the vibration combination of the driving signal 250 has two half sine wave waveforms 251 and 253 connected by a DC waveform 252.

In the embodiment of the invention, when the touch signal Stouch corresponds to the single-click touch, the driving signal (such as 210, 220, 230, 240, 250) may include one to three consecutive single sine wave waveforms, one half sine wave waveform, or two half sine wave waveforms connected by a DC waveform. Moreover, the vibration combination of the single-click touch is mainly based on the single sine wave waveform and/or the half sine wave waveform. However, in other embodiments, the vibration combination of the single-click touch may also include a square wave waveform, which is not limited by the invention.

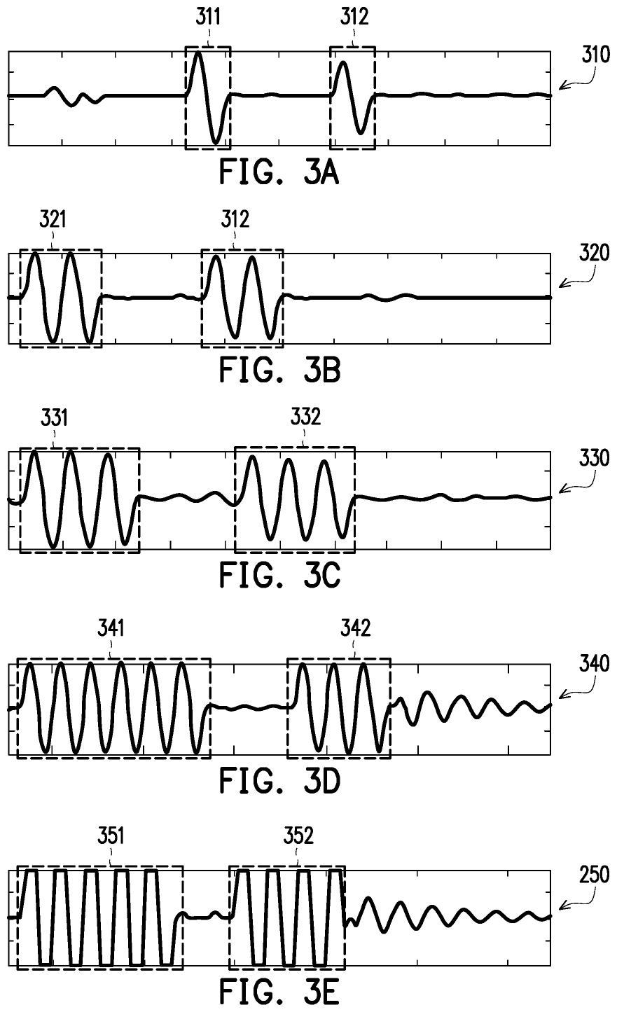

FIG. 3A to FIG. 3E are schematic diagrams of driving waveforms of a second type tactile feedback expression according to an embodiment of the invention. Referring to FIG. 3A to FIG. 3E, in the embodiment, the second type tactile feedback expression corresponds to a double-click touch (i.e., the touch signal Stouch corresponds to the double-click touch), at this time, driving signals 310, 320, 330, 340, and 350 have two sets of vibration combinations separated (or connected) by a DC waveform. Further, in the vibration combination of the double-click touch, an interval between the vibration waveforms has to be greater than 0.01 seconds in order to be perceived as a continuous press, and the interval between the vibration waveforms has to be less than 0.075 seconds in order to be not perceived as two separate presses.

In FIG. 3A, the driving signal 310 has two vibration combinations 311 and 312, and the vibration combinations 311 and 312 respectively have a single sine wave waveform. In FIG. 3B, the driving signal 320 has two vibration combinations 321 and 322, and the vibration combinations 321 and 322 respectively have two consecutive single sine wave waveforms. In FIG. 3C, the driving signal 330 has two vibration combinations 331 and 332, and the vibration combinations 331 and 332 respectively have three consecutive single sine wave waveforms. In FIG. 3D, the driving signal 340 has two vibration combinations 341 and 342, the vibration combination 341 has six consecutive single sine wave waveforms, and the vibration combination 342 has three consecutive single sine wave waveforms. In FIG. 3E, the driving signal 350 has two vibration combinations 351 and 352, the vibration combination 351 has five consecutive square wave waveforms, and the vibration combination 352 has three consecutive square wave waveforms and a half square wave waveform. The driving signal 340 and 350 may include a plurality of single sine wave waveforms or a plurality of half sine wave waveforms with successively reduced amplitudes (fading out), and the embodiment of the invention is not limited thereto.

In the embodiment of the invention, when the touch signal Stouch corresponds to a double-click touch, the driving signal (such as 310, 320, 330, 340, 350) may include a plurality of single sine wave waveforms divided into two sets of vibration combinations by a DC waveform.

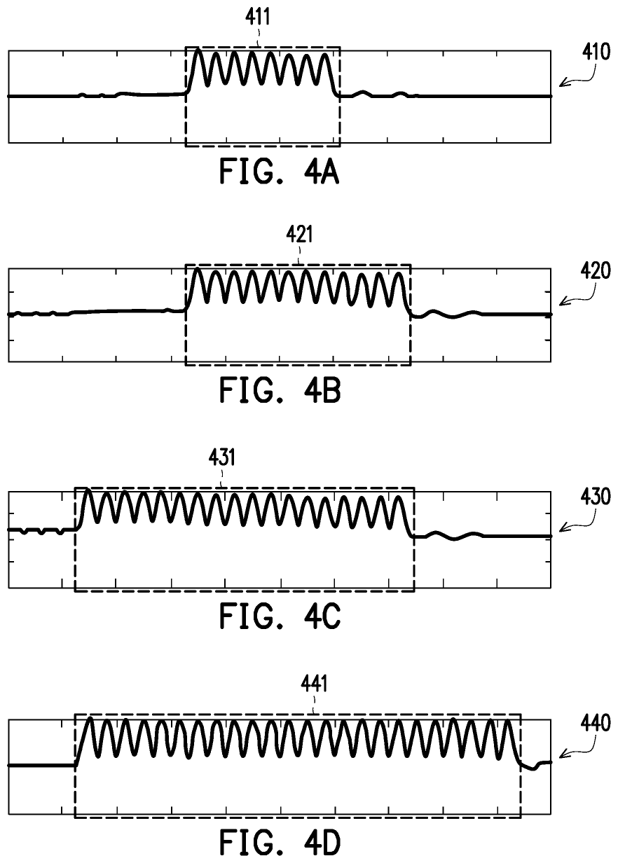

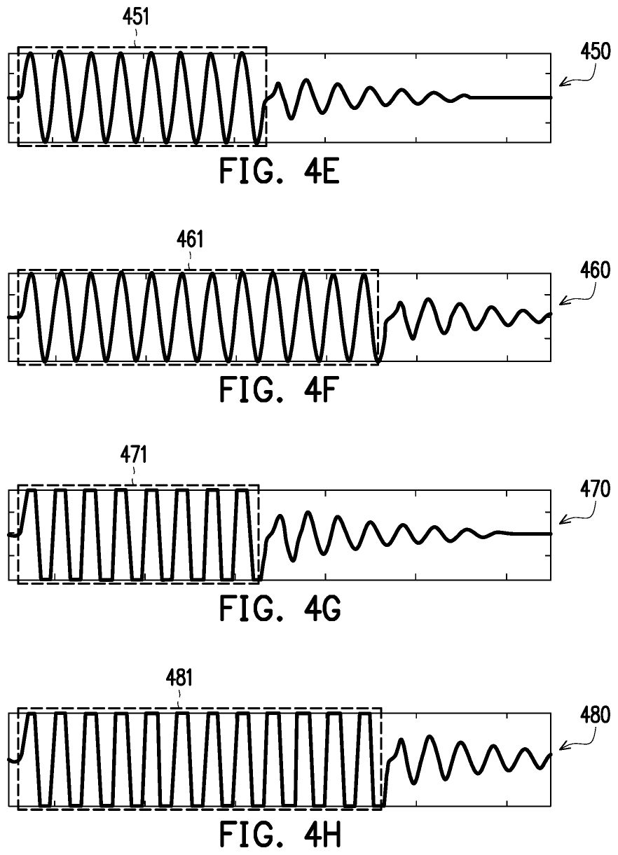

FIG. 4A to FIG. 4H are schematic diagrams of driving waveforms of a third type tactile feedback expression according to an embodiment of the invention. Referring to FIG. 4A to FIG. 4H, in the embodiment, the third type tactile feedback expression corresponds to a touch beep (i.e., the touch signal Stouch corresponds to the touch beep), at this time, driving signals 410, 420, 430, 440, 450, 460, 470 and 480 have one set of vibration combination of six or more vibration waveforms. Further, the vibration combination of the touch beep requires to be ≥0.3 seconds, and the vibration waveforms are repeated by a number of times ≥6 to achieve a continuous touch feeling.

In FIG. 4A, the vibration combination of the driving signal 410 has eight consecutive half sine wave waveforms 411. In FIG. 4B, the vibration combination of the driving signal 420 has twelve consecutive half sine wave waveforms 421. In FIG. 4C, the vibration combination of the driving signal 430 has eighteen consecutive half sine wave waveforms 431. In FIG. 4D, the vibration combination of the driving signal 440 has twenty-four consecutive half sine wave waveforms 441.

In FIG. 4E, the vibration combination of the driving signal 450 has eight consecutive single sine wave waveforms 451. In FIG. 4F, the vibration combination of the driving signal 460 has twelve consecutive single sine wave waveforms 461. In FIG. 4G, the vibration combination of the driving signal 470 has eight consecutive square wave waveforms 471. In FIG. 4H, the vibration combination of the driving signal 480 has twelve consecutive square wave waveforms 481. The driving signals 450, 460, 470, and 480 may include a plurality of single sine wave waveforms or a plurality of half sine wave waveforms with successively reduced amplitudes (fading out), and the embodiment of the invention is not limited thereto.

In the embodiment of the invention, when the touch signal Stouch corresponds to the touch beep, the driving signal (such as 410, 420, 430, 440, 450, 460, 470, 480) includes at least six consecutive half sine wave waveforms, or at least six consecutive single sine wave waveforms.

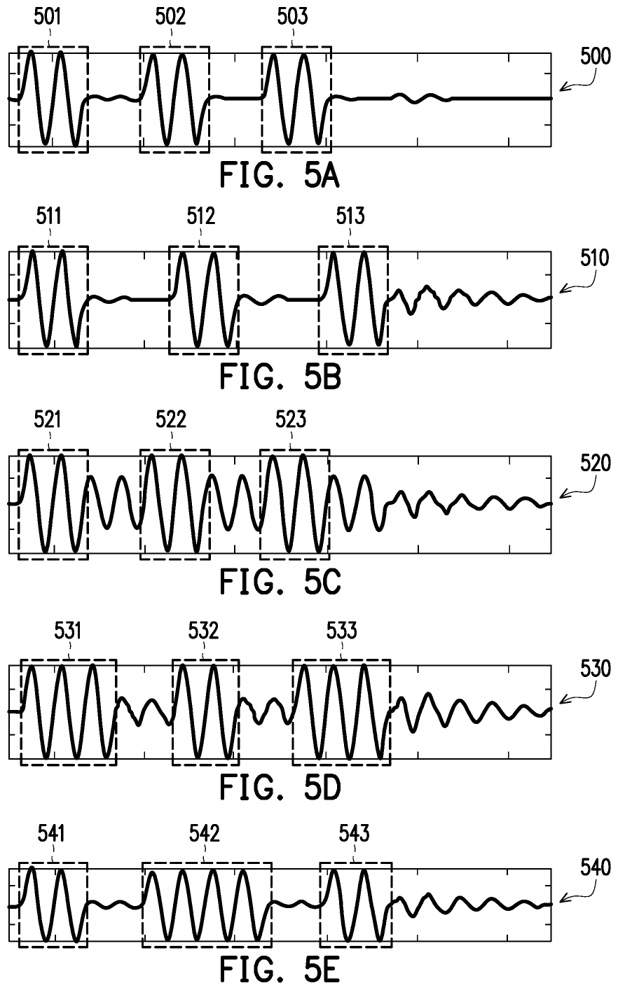

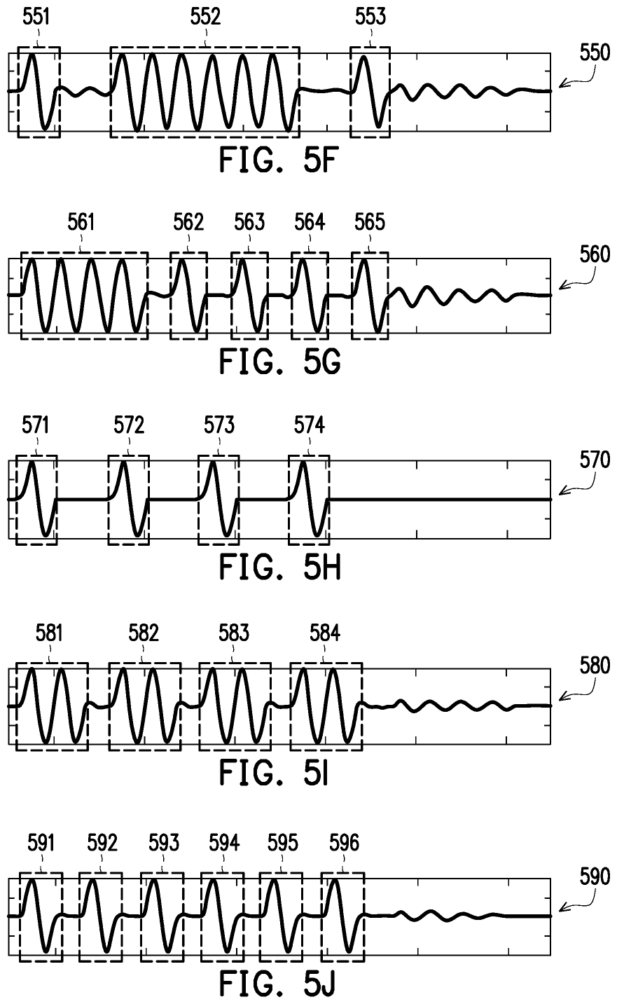

FIG. 5A to FIG. 5J are schematic diagrams of driving waveforms of a fourth type tactile feedback expression according to an embodiment of the invention. Referring to FIG. 5A to FIG. 5J, in the embodiment, the fourth type tactile feedback expression corresponds to a touch warning (i.e., the touch signal Stouch corresponds to the touch warning), at this time, driving signals 500, 510, 520, 530, 540, 550, 560, 570, 580 and 590 have three or more sets of vibration combinations. Further, the vibration combination of the touch warning requires to be ≥0.4 seconds, and the vibration waveforms require to repeat a characteristic for more than once to achieve a warning effect.

In FIG. 5A, the driving signal 500 has three vibration combinations 501, 502, and 503 separated (or connected) by DC waveforms, and the vibration combinations 501, 502, and 503 respectively have two consecutive single sine wave waveforms. In FIG. 5B, the driving signal 510 has three vibration combinations 511, 512, and 513 separated (or connected) by DC waveforms, and includes a plurality of single sine wave waveforms with successively reduced amplitudes (fading out), where the vibration combinations 511, 512 and 513 respectively have two consecutive single sine wave waveforms. In FIG. 5C, the driving signal 520 has three vibration combinations 521, 522, and 523 respectively separated (or connected) by two single sine wave waveforms with reduced amplitudes, and includes a plurality of single sine wave waveforms with successively reduced amplitudes (fading out), where the vibration combinations 521, 522, and 523 respectively have two consecutive single sine wave waveforms.

In FIG. 5D, the driving signal 530 has three vibration combinations 531, 532, and 533 respectively separated (or connected) by two single sine wave waveforms with reduced amplitudes, and includes a plurality of single sine wave waveforms with successively reduced amplitudes (fading out), where the vibration combinations 531 and 533 respectively have three consecutive single sine wave waveforms, and the vibration combination 532 has two consecutive single sine wave waveforms. In FIG. 5E, the driving signal 540 has three vibration combinations 541, 542, and 543 separated (or connected) by DC waveforms, and includes a plurality of single sine wave waveforms with successively reduced amplitudes (fading out), where the vibration combinations 541 and 543 respectively have two consecutive single sine wave waveforms, and the vibration combination 542 has four consecutive single sine wave waveforms.

In FIG. 5F, the driving signal 550 has three vibration combinations 551, 552, and 553 separated (or connected) by DC waveforms, and includes a plurality of single sine wave waveforms with successively reduced amplitudes (fading out), where the vibration combinations 551 and 553 respectively have one single sine wave waveform, and the vibration combination 552 has six consecutive single sine wave waveforms. In FIG. 5G, the driving signal 560 has five vibration combinations 561, 562, 563, 564, and 565 separated (or connected) by DC waveforms, and includes a plurality of single sine wave waveforms with successively reduced amplitudes (fading out), where the vibration combination 561 has four consecutive single sine wave waveforms, and the vibration combinations 562, 563, 564 and 565 respectively have one single sine wave waveform.

In FIG. 5H, the driving signal 570 has four vibration combinations 571, 572, 573, and 574 separated (or connected) by DC waveforms, and the vibration combinations 571, 572, 573, and 574 respectively have one single sine wave waveform. In FIG. 5I, the driving signal 580 has four vibration combinations 581, 582, 583, and 584 separated (or connected) by DC waveforms, and the vibration combinations 581, 582, 583, and 584 respectively have two consecutive single sine wave waveforms. In FIG. 5J, the driving signal 570 has six vibration combinations 591, 592, 593, 594, 595, and 596 separated (or connected) by DC waveforms, and the vibration combinations 591, 592, 593, 594, 595, and 596 respectively have a single sine wave waveform.

In the embodiment of the invention, when the touch signal Stouch corresponds to a touch warning, the driving signal (such as 500, 510, 520, 530, 540, 550, 560, 570, 580, 590) includes a plurality of single sine wave waveforms separated into a plurality of sets of vibration combinations by a plurality of DC waveforms, or a plurality of single sine wave waveforms separated into a plurality of sets of vibration combinations by a plurality of single sine wave waveforms with reduced amplitudes.

In the embodiment, the amplitudes of a plurality of the single sine wave waveforms or the amplitudes of a plurality of the half sine wave waveforms in the driving signal (such as Sdrive) may be the same; the amplitudes of a plurality of the single sine wave waveforms or the amplitudes of a plurality of the half sine wave waveforms in the driving signal (such as Sdrive) may be sequentially increased; the amplitudes of a plurality of the single sine wave waveforms or the amplitudes of a plurality of the half sine wave waveforms in the driving signal (such as Sdrive) may be sequentially decreased; alternatively, the amplitudes of a plurality of the single sine wave waveforms or the amplitudes of a plurality of the half sine wave waveforms in the driving signal (such as Sdrive) may be periodically increased and decreased.

In summary, the touch display device with vibration feedback of the embodiment of the invention controls a vibration mode of the actuator in response to the touch signal of the touch display panel, so as to generate a sharp pressing feeling, a continuous feeling . . . and other different tactile feelings through the vibration mode of the actuator. In this way, a position or an icon touched by a user may be fed back through different tactile sensations, and since the user may make confirmation without using eyes, it improves driving safety of the user or operation convenience of visually impaired people.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

1. A touch display device with vibration feedback, comprising:
a touch display panel, configured to provide a touch signal;
at least one actuator, contacting the touch display panel; and
a control circuit, coupled to the touch display panel and the actuator, and controlling the at least one actuator to generate vibration feedback corresponding to a driving signal comprising a plurality of vibration waveforms during a tactile sensing period in response to the touch signal, wherein at least one of the plurality of vibration waveforms is a single sine wave waveform or a half sine wave waveform,
wherein when the touch signal corresponds to a touch beep, the driving signal comprises at least 8 consecutive half sine wave waveforms or at least 12 consecutive single sine wave waveforms.

2. The touch display device with vibration feedback as claimed in claim 1, wherein when the driving signal uses 2 to 12 vibration waveforms to represent a touch action, the tactile sensing period is between 6 ms and 120 ms.

3. The touch display device with vibration feedback as claimed in claim 1, wherein amplitudes of a plurality of single sine wave waveforms or amplitudes of a plurality of half sine wave waveforms in the driving signal are the same as each other.

4. The touch display device with vibration feedback as claimed in claim 1, wherein amplitudes of a plurality of single sine wave waveforms or amplitudes of a plurality of half sine wave waveforms in the driving signal are sequentially increased.

5. The touch display device with vibration feedback as claimed in claim 1, wherein amplitudes of a plurality of single sine wave waveforms or amplitudes of a plurality of half sine wave waveforms in the driving signal are sequentially decreased.

6. The touch display device with vibration feedback as claimed in claim 1, wherein amplitudes of a plurality of single sine wave waveforms or amplitudes of a plurality of half sine wave waveforms in the driving signal are periodically increased and decreased.

7. The touch display device with vibration feedback as claimed in claim 1, wherein a vibration frequency of the at least one actuator is between 100 Hz and 300 Hz.

8. The touch display device with vibration feedback as claimed in claim 7, wherein the vibration frequency of the at least actuator applied to the touch display panel is between 140 Hz and 190 Hz.

9. The touch display device with vibration feedback as claimed in claim 1, wherein when the touch signal corresponds to a single-click touch, the driving signal comprises 1 to 3 consecutive single sine wave waveforms, one half sine wave waveform, or two half sine wave waveforms connected by a direct current waveform.

10. The touch display device with vibration feedback as claimed in claim 1, wherein when the touch signal corresponds to a double-click touch, the driving signal comprises a plurality of single sine wave waveforms divided into two sets of vibration combinations by a direct current waveform.

11. (canceled)

12. The touch display device with vibration feedback as claimed in claim 1, wherein when the touch signal corresponds to a touch warning, the driving signal comprises a plurality of single sine wave waveforms divided into at least three sets of vibration combinations by a plurality of direct current waveforms, or a plurality of single sine wave waveforms divided into at least three sets of vibration combinations by a plurality of single sine wave waveforms with reduced amplitudes.

13. The touch display device with vibration feedback as claimed in claim 1, wherein the at least one actuator is respectively a linear resonant actuator.
